(19) United States
(12) Patent Application Publication
(10) Pub. No.: US 2023/0132083 A1
(43) Pub. Date: Apr. 27, 2023

(54) APPARATUS AND METHOD FOR TRANSFERING AND COOLING A COMPRESSED FUEL GAS

(71) Applicant: NANOSUN IP LIMITED, Lancaster (GB)

(72) Inventors: Paul Joseph HODGSON, Cambridge (GB); Joseph HOBBS, Lancaster (GB)

(21) Appl. No.: 17/914,429

(22) PCT Filed: Mar. 26, 2021
(86) PCT No.: PCT/GB2021/050763

§ 371 Date: Sep. 26, 2022

(30) Foreign Application Priority Data
Mar. 27, 2020 (GB) 2004521.7

(51) Int. Cl. F17C 5/06

(52) U.S. Cl. CPC F17C 5/06; F17C 2270/0139; F17C 2265/065; F17C 2227/036; F17C 2225/036; F17C 2223/036; F17C 2221/012; F17C 2221/035

(57) ABSTRACT

A method and apparatus for cooling a compressed fuel gas during transfer of the gas from a source vessel to a receiving vessel. The method includes receiving a portion of the fuel gas from the source vessel in an intermediate vessel. Then, fluidly isolating the intermediate vessel from the source vessel. Work is then extracted from the fuel gas by causing or allowing expansion of the fuel gas, thereby cooling the fuel gas. Finally, the cooled portion of fuel gas is released from the intermediate vessel to the receiving vessel.

This invention relates to a method and apparatus for transferring and cooling a compressed fuel gas. In particular, for cooling a fuel gas during transfer from a source vessel to a receiving vessel.

### BACKGROUND

When hydrogen powered vehicles or machines are refueled, hydrogen gas is transferred from a high-pressure storage vessel to a receiving tank or vessel in the vehicle or machine. The addition of the gas into the receiving vessel compresses the gas in the receiving vessel leading to an increase in temperature. For fast refuelling, the fast addition of gas to the receiving vessel leads to rapid compression of the gas in the receiving vessel causing high gas temperatures in the receiving vessel. High temperatures of the gas in the receiving vessel can lead to a weakening in the receiving vessel wall. Thus, the lifetime of the receiving vessel is reduced. Additionally, over time, the high temperature of the gas in the receiving cylinder will reduce until it reaches an equilibrium state with the cooler temperature of the ambient surroundings. Thus, the gas pressure in the receiving vessel is reduced and hence the mass of gas stored in the receiving vessel is lower than its maximum capacity.

To avoid high gas temperatures in the receiving vessel, the rate of gas addition into the vessel may be limited. This may be achieved by filling the receiving vessel in stages, by adding an amount of gas to the receiving vessel then waiting for the heat generated from the gas transfer to dissipate through the vessel wall and from the vessel exterior surface through conduction, convection or radiation. Once the heat has sufficiently dissipated more gas can be added to the receiving vessel. This process leads to a slow rate of refueling.

Alternatively, the hydrogen gas may be cooled prior to being transferred to the receiving vessel. Typically, the gas may be cooled to between 0° C. and −40° C. prior to transfer into the receiving vessel. This allows for fast refuelling of hydrogen powered vehicles or machines. A refrigeration cycle may be used to cool the hydrogen through a heat exchanger. However, chilling hydrogen in this way is an energy-intensive given the high specific heat capacity of hydrogen of 14.3 kJ/kgK. Such problems are not unique to hydrogen gas and may also be associated with other compressed fuel gases.

It is an object of embodiments of the invention to at least mitigate one or more of the problems of the prior art. In particular, the invention provides a method and apparatus for improving the cooling of a compressed fuel gas during transfer from a source vessel to a receiving vessel.

### BRIEF SUMMARY OF THE DISCLOSURE

In accordance with an aspect of the present invention there is provided a method of cooling a compressed fuel gas during transfer of the gas from a source vessel to a receiving vessel, the method comprising:

receiving a portion of the fuel gas from the source vessel in an intermediate vessel;

fluidly isolating the intermediate vessel from the source vessel;

causing or allowing expansion of the portion of fuel gas in the intermediate vessel thereby cooling the fuel gas;

releasing the cooled portion of fuel gas from the intermediate vessel to the receiving vessel.

In certain embodiments, the step of causing or allowing expansion of the portion of fuel gas in the intermediate vessel thereby cooling the fuel gas may comprise extracting work from the portion of fuel gas or transferring work away from the portion of fuel gas.

The fuel gas in the source vessel may have a pressure greater than 100 bar. The fuel gas may be or may include hydrogen, methane, or biogas.

An inlet valve may be provided along a first fluid pathway connecting the source vessel to the inlet of the intermediate vessel, and the step of fluidly isolating the intermediate vessel from the source vessel may comprise closing the inlet valve.

The intermediate vessel may include a first outlet for permitting the release of the cooled gas from the intermediate vessel to the receiving vessel.

An outlet valve may be provided along a second fluid pathway connecting the second outlet of the intermediate vessel to the receiving vessel, and wherein the outlet valve may be opened and closed to selectively put the intermediate vessel in fluid communication with the receiving vessel.

An auxiliary intermediate vessel may be provided that is in selective fluid communication with each of the source vessel and the receiving vessel such that a further portion of fuel gas may be: (i) received from the source vessel in the auxiliary intermediate vessel, (ii) caused or allowed to expand and thereby be cooled, and (iii) subsequently released to the receiving vessel.

In certain embodiments, work may be extracted from the expanding portion of fuel gas by positive displacement.

In certain embodiments, the intermediate vessel may contain a liquid that is displaceable out of a second outlet of the intermediate vessel by the portion of fuel gas received in the intermediate vessel, and wherein the liquid may be further displaced out of the first outlet during expansion of the portion of fuel gas. The liquid may be an ionic liquid. The intermediate vessel may be a column having an inlet at a top end for receiving the portion of fuel gas from the source vessel, and the second outlet may be provided at a bottom end. Prior to receiving the portion of fuel gas from the source vessel in the intermediate vessel, the intermediate vessel may be substantially entirely filled with the liquid. The step of releasing the cooled portion of fuel gas from the intermediate vessel to the receiving vessel may comprise causing the liquid to move so as to displace and expel the cooled portion of gas from the intermediate vessel. The auxiliary intermediate vessel may contain a liquid that is displaceable out of a second outlet of the auxiliary intermediate vessel and wherein the second outlet of the auxiliary intermediate vessel may be in selective fluid communication with the second outlet of the intermediate vessel such that displacement of liquid in the intermediate vessel may cause displacement of liquid in the auxiliary intermediate vessel.

In certain embodiments, the intermediate vessel may contain a diaphragm that is moveable by the portion of fuel gas received in the intermediate vessel. The step of releasing the cooled portion of fuel gas from the intermediate vessel to the receiving vessel may comprise causing the diaphragm to move so as to displace and expel the cooled portion of fuel gas from the intermediate vessel.

In certain embodiments, the intermediate vessel may contain a piston that is moveable by the portion of gas received in the intermediate vessel. The step of releasing the cooled portion of fuel gas from the intermediate vessel to the receiving vessel may comprise causing the piston to move so as to displace and expel the cooled portion of fuel gas from the intermediate vessel.

In certain embodiments, the method may comprise receiving a non-cooled portion of fuel gas in the receiving vessel from the source vessel, wherein the non-cooled portion of fuel gas does not enter the intermediate vessel prior to being received in the receiving vessel.

In accordance with an aspect of the present invention there is provided an apparatus for transferring and cooling a fuel gas comprising:

a source vessel for containing the fuel gas;

an intermediate vessel fluidly connected to the source vessel by a first fluid pathway, the intermediate vessel including a positive displacement expander means;

an inlet valve along the first fluid pathway for selectively permitting fuel gas to flow along the first fluid pathway;

a second fluid pathway connected to the intermediate vessel and connectable to a receiving vessel; and

an outlet valve along the second fluid pathway for selectively permitting fuel gas to flow along the second fluid pathway;

wherein the intermediate vessel is configured to receive a portion of fuel gas from the source vessel and the positive displacement expander means may be displaced by the portion of fuel gas so as to extract work from the portion of fuel gas and cause it to cool, whereby the cooled portion of fuel gas may be released from the intermediate vessel to the receiving vessel.

The source vessel may contain a fuel gas. The fuel gas in the source vessel may have a pressure greater than 100 bar. The fuel gas may be or may include hydrogen, methane, or biogas.

The apparatus may further comprise an auxiliary intermediate vessel that is in selective fluid communication with each of the source vessel and the receiving vessel such that a further portion of fuel gas may be: (i) received from the source vessel in the auxiliary intermediate vessel, (ii) caused or allowed to expand and thereby be cooled, and (iii) subsequently released to the receiving vessel.

In certain embodiments, the positive displacement expander means may comprise a liquid contained in the intermediate vessel that is displaceable out of a first outlet of the intermediate vessel by the portion of fuel gas received in the intermediate vessel, and wherein the liquid is further displaced out of the first outlet during expansion of the portion of fuel gas. The liquid may be an ionic liquid. The intermediate vessel may be a column having an inlet at a top end fluidly connected to the first fluid pathway, and the second outlet may be provided at a bottom end. Prior to receiving the portion of fuel gas from the source vessel in the intermediate vessel, the intermediate vessel may be substantially entirely filled with the liquid. The apparatus may further comprise an actuator means for causing the liquid to move so as to displace and expel the cooled portion of fuel gas from the intermediate vessel. The auxiliary intermediate vessel may contain a liquid that is displaceable out of a first outlet of the auxiliary intermediate vessel and wherein the first outlet of the auxiliary intermediate vessel is in selective fluid communication with the first outlet of the intermediate vessel such that displacement of liquid in the intermediate vessel may cause displacement of liquid in the auxiliary intermediate vessel.

In certain embodiments, the positive displacement expander means may comprise a diaphragm that is moveable in the intermediate vessel by the portion of fuel gas received in the intermediate vessel. The apparatus may further comprise an actuator means for causing the diaphragm to move so as to displace and expel the cooled portion of fuel gas from the intermediate vessel.

In certain embodiments, the positive displacement expander means may comprise a piston that is moveable in the intermediate vessel by the portion of fuel gas received in the intermediate vessel. The apparatus may further comprise an actuator means for causing the piston to move so as to displace and expel the cooled portion of fuel gas from the intermediate vessel.

The apparatus may comprise a third fluid pathway fluidly connecting the source vessel to the receiving vessel, and a bypass valve disposed along the third fluid pathway for selectively permitting direct flow of fuel gas from the source vessel to the receiving vessel.

The apparatus may comprise a receiving vessel connected to the intermediate vessel by the second fluid pathway. The receiving vessel may comprise an automobile fuel tank.

### BRIEF DESCRIPTION OF THE DRAWINGS

Embodiments of the invention are further described hereinafter with reference to the accompanying drawings, in which:

FIG. 1 schematically shows an apparatus for transferring and cooling a fuel gas according to a first embodiment of the present invention;

FIGS. 2 to 7 schematically show an apparatus for transferring and cooling a fuel gas in use according to a second embodiment of the present invention;

FIG. 8 schematically shows an apparatus for transferring and cooling a fuel gas in use according to a third embodiment of the present invention;

FIGS. 9 to 12 schematically show an apparatus for transferring and cooling a fuel gas in use according to a fourth embodiment of the present invention;

FIG. 13 schematically shows an apparatus for transferring and cooling a fuel gas according to a fifth embodiment of the present invention;

FIG. 14 schematically shows an apparatus for transferring and cooling a fuel gas according to a sixth embodiment of the present invention; and

FIG. 15 schematically shows an apparatus for transferring and cooling a fuel gas according to a seventh embodiment of the present invention.

### DETAILED DESCRIPTION

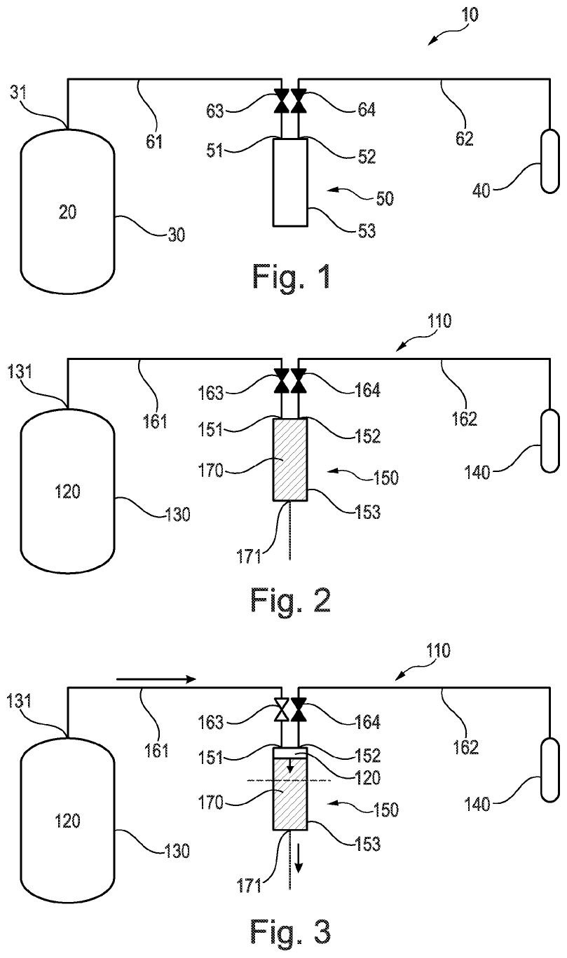

FIG. 1 schematically shows an apparatus 10 according to a first embodiment of the invention. The apparatus 10 is configured to transfer a fuel gas 20 from a source vessel 30 to a receiving vessel 40. The transfer occurs via an intermediate vessel 50 in which the fuel gas 20 is cooled.

According to the first embodiment, the apparatus 10 comprises the source vessel 30 for containing the fuel gas 20. The fuel gas 20 may comprise any fuel that is both stored and used in a gaseous state. Non-limiting examples of such fuel are gases that are or include hydrogen, methane or biogas. The fuel gas 20 contained in the source vessel 30 may contain a compressed fuel gas 20. In certain embodiments, the fuel gas 20 in the source vessel 30 may have a pressure greater than 100 bar. The storage vessel may be any vessel suitable for containing the fuel gas 20.

The apparatus 10 comprises the intermediate vessel 50 which is configured to receive a portion of fuel gas 20 from the source vessel 30. A first fluid pathway 61 fluidly connects the intermediate vessel 50 to the source vessel 30. The first fluid pathway 61 may be connected to an inlet 51 of the intermediate vessel 50. The first fluid pathway 61 may be connected to an outlet 31 of the source vessel 30. In use, fuel gas 20 may flow along the first fluid pathway 61 so that a portion of the fuel gas 20 from the source vessel 30 may be received by the intermediate vessel 50. An inlet valve 63 is provided along the first fluid pathway 61 for selectively permitting the fuel gas 20 to flow along the first fluid pathway 61. When the inlet valve 63 is closed, the intermediate vessel 50 is fluidly isolated from the source vessel 30 and when the inlet valve 63 is open, the intermediate vessel 50 may receive fuel gas 20 from the source vessel 30. Thus, the inlet valve 63 may be used to control the transfer of the fuel gas 20 between the source vessel 30 and intermediate vessel 50.

The intermediate vessel 50 includes a positive displacement expander means 53. The positive displacement expander means 53 may be any suitable type of positive displacement expanded, including but not limited to a liquid column, a diaphragm, a piston or a reciprocating compressor. However, any alternative may be utilised. The positive displacement expander means 53 causes or allows the portion of fuel gas 20 received in the intermediate vessel 50 to expand. The expansion of the portion of fuel gas 20 is substantially an isentropic process. Therefore, the fuel gas 20 is cooled (i.e. the temperature decreases) as it expands. In certain non-limiting embodiments, the fuel gas 20 may be cooled to a target temperature that is between approximately 0° C. and −40° C. In other embodiments, the target temperature may be greater than 0° C. or less than −40° C. To achieve this, the positive displacement expander means 53 may be displaced by the portion of fuel gas 20 received in the intermediate vessel 50 so that work is extracted from the portion of fuel gas 20. The positive displacement expander means 53 and its use in cooling the fuel gas 20 is described in further detail below with reference to the embodiments shown in FIGS. 2 to 15.

The apparatus 10 comprises a second fluid pathway 62 connected to the intermediate vessel 50. The second fluid pathway 62 allows the cooled fuel gas 20 to flow from the intermediate vessel 50. The second fluid pathway 62 may be coupled to a first outlet 52 of the intermediate vessel 50. A receiving vessel 40 is connectable to the second fluid pathway 62. Thus, the cooled fuel gas 20 may be transferred from the intermediate vessel 50 to the receiving vessel 40. In certain embodiments, the receiving vessel 40 may comprise a fuel tank in a gas-powered vehicle or gas-powered machine. In general, the pressure of fuel gas 20 in the receiving vessel 40 is less than the pressure of fuel in the source vessel 30. In certain embodiments, the receiving vessel may not be in or part of a vehicle. For example, the receiving vessel 40 may be a buffer tank where cooled fuel gas may be stored temporarily before being distributed into one or more vehicle fuel tanks.

An outlet valve 64 is provided along the second fluid pathway 62 for selectively permitting the cooled fuel gas 20 to flow along the second fluid pathway 62. Thus, the outlet valve 64 may be opened and closed to selectively put the intermediate vessel 50 in fluid communication with the receiving vessel 40. When the outlet valve 64 is closed, the receiving vessel 40 is fluidly isolated from the intermediate vessel 50, and when the outlet valve 64 is open, the receiving vessel 40 may receive cooled fuel gas 20 from the intermediate vessel 50. The valves may be any suitable valve, including but not limited to one-way valves, pressure-controlled valves, or other types of controlled valves.

The apparatus 10 enables fuel gas 20 to be transferred from the source vessel 30 to the receiving vessel 40 via the intermediate vessel 50. The inlet and outlet valves 63, 64 may be used to control the transfer of fuel gas 20 between the vessels 30, 40. The intermediate vessel 50 and the positive displacement expander means 53 and their use in transferring and cooling the fuel gas 20 is now described in further detail with reference to the embodiments shown in FIGS. 2 to 15.

FIGS. 2 to 7 schematically show the use of an apparatus 110 according to a second embodiment of the invention. Reference numerals in FIGS. 2 to 6 correspond to those used in FIG. 1 with respect to alike components and features but are transposed by 100. In the second embodiment, the positive displacement expander means 153 is a liquid column. Thus, the intermediate vessel 150 is a column. The column may have an inlet 151 at a top end for receiving the portion of fuel gas 120 from the source vessel 130 (in alternative embodiments, the inlet 151 may be positioned elsewhere). The inlet 151 is fluidly connected to the first fluid pathway 161. Additionally, the liquid column has a first outlet 152 in fluid communication with the second fluid pathway 162. The first outlet 152 may be at a top end of the column.

Since the positive displacement expander means 153 is a liquid column, the intermediate vessel 150 contains a liquid 170. The column also has a second outlet 171 which may be provided at a bottom end of the column. A valve may be provided at the second outlet 171 to only permit fluid flow in/out the second outlet 171 when the liquid is pressurized. The liquid 170 contained in the column may be displaced through the second outlet 171. In certain embodiments, the liquid 170 may be an ionic fluid. An ionic liquid comprises salts that are liquid at ambient temperatures. Use of an ionic fluid is advantageous because the fluids often have low vapour pressures and appropriate ionic liquids can be selected with a limited ability to dissolve hydrogen or other gases of interest. Certain suitable ionic liquids are those with a melting point that is lower than −50° C. Thus, the efficiency of the apparatus 110 may be improved, whilst ensuring low contamination of the fuel gas 120 by the liquid.

FIGS. 2 to 6 illustrate the method of transferring and cooling fuel gas 120 using the apparatus 110 according to the second embodiment. FIG. 2 shows an initial state of the apparatus 110. In the initial state, the intermediate vessel 150 is substantially entirely filled with the liquid 170. The inlet and the outlet valves 163, 164 are closed. As such, fuel gas 120 does not flow through the apparatus 110.

FIG. 3 shows the apparatus 110 in a first stage of the method where the intermediate vessel 150 receives a portion of the fuel gas 120 from the source vessel 130. The inlet valve 163 is opened to bring the source vessel 130 into fluid communication with the intermediate vessel 150. The outlet valve 164 remains closed. Thus, fuel gas 120 flows through the first fluid pathway 161 into the intermediate vessel 150. The fuel gas 120 expands as it enters the intermediate vessel 150 transferring work to the liquid 170. The liquid 170 is consequently displaced out of the second outlet 171 of the intermediate vessel 150. The expansion of the fuel gas 120 into the intermediate vessel 150 may be substantially isentropic if losses through friction and heat transfer are neglected. As such, the expansion results in a reduction in temperature and pressure of the fuel gas 120 in both the source vessel 130 and the intermediate vessel 150. Thus, cooling the fuel gas 120. In general, the volume of the source vessel 130 may greater than that of the intermediate vessel 150. Thus, the change in temperature in the first stage may be very minimal.

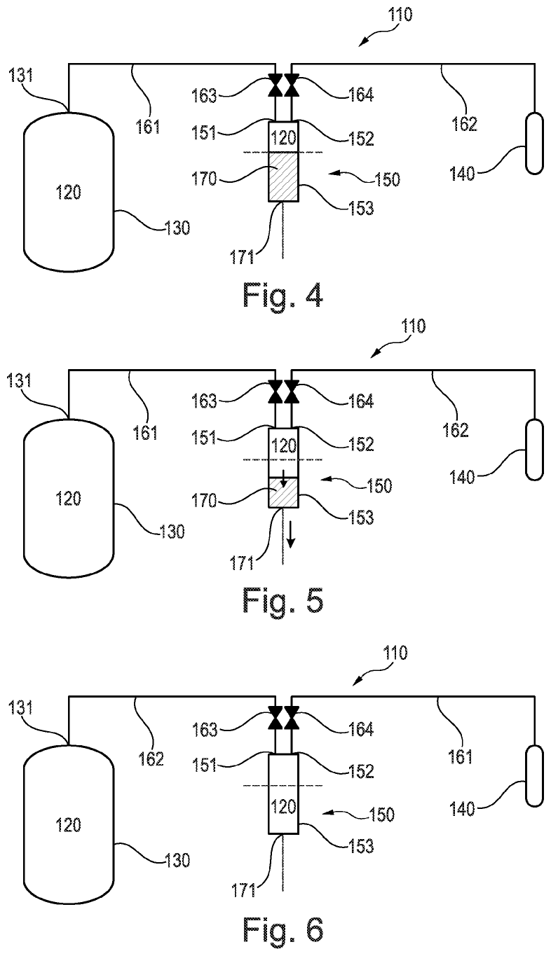

During the first stage, the pressure of the fuel gas 120 in the intermediate vessel 150 is substantially the same as the pressure of the fuel gas 120 in the source vessel 130. The fuel gas 120 may continue to fill the intermediate vessel 150, displacing the liquid 170, until the amount of fuel gas 120 admitted would have substantially the same pressure as the receiving vessel 140 if the fuel gas 120 expanded to entirely fill the intermediate vessel. Once a sufficient amount of fuel gas 120 has been received by the intermediate vessel 150, the inlet valve 163 may be closed to fluidly isolate the intermediate vessel 150 from the source vessel 130. When the inlet valve 163 is closed, the intermediate vessel 150 may be partially filled with fuel gas 120 and partially filled with the liquid 170 as shown in FIG. 4.

FIGS. 5 and 6 show the apparatus 110 in a second stage of the method where the fuel gas 120 is caused or allowed to expand further in the intermediate vessel 150, further cooling the portion of the fuel gas 120 in the intermediate vessel 150. The liquid 170 remaining within the intermediate vessel 150 may be released to allow the fuel gas 120 to expand. Both the inlet and outlet valves 163, 164 may remain closed whilst the liquid 170 is further displaced out of the second outlet 171 by expansion of the fuel gas 120. As the fuel gas 120 expands, work is done on the liquid 170. The expansion process may be substantially isentropic, thus, the work done on the liquid 170 may result in a reduction of the pressure and temperature of the fuel gas 120. Thus, the portion of fuel gas 120 is cooled. The fuel gas 120 expands until it substantially entirely fills the intermediate vessel 150 as shown in FIG. 6. Once the fuel gas 120 has expanded to fill the intermediate vessel 150 the fuel gas 120 may be at substantially the same pressure as the receiving vessel 140.

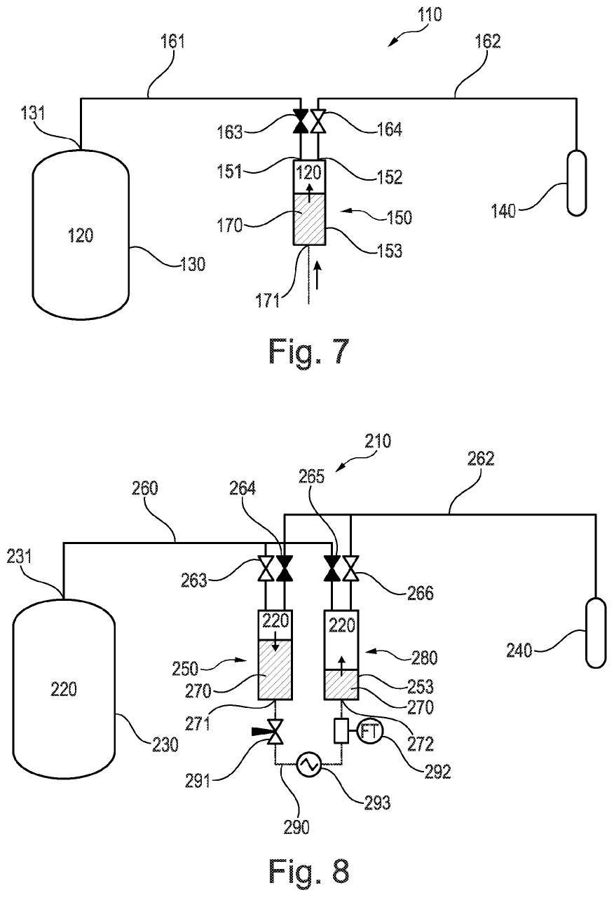

FIG. 7 shows a third stage of the method where the cooled portion of the fuel gas 120 is released from the intermediate vessel 150 to the receiving vessel 140. Once the fuel gas 120 has expanded to fill the intermediate vessel 150, the outlet valve 164 is opened so that the intermediate vessel 150 and the receiving vessel 140 are in fluid communication. Thus, the cooled portion of the fuel gas 120 is released from the intermediate vessel 150. When the outlet valve 164 is opened, substantially none or very little of the cooled fuel gas 120 initially flows from the intermediate vessel 150 to the receiving vessel 140 because the fuel gas 120 in the vessels 150, 140 are at substantially the same pressure. To cause flow of the cooled fuel gas 120 into the receiving vessel 140, the liquid 170 is forced through the second outlet 171 into the intermediate vessel 150 (using a pump, for example). The liquid 170 entering the intermediate vessel 150 displaces the fuel gas 120 causing the fuel gas 120 to be expelled from the intermediate vessel 150 and flow along the second pathway into the receiving vessel 140. The apparatus 110 may comprise an actuator or actuator means (not shown) for causing the liquid 170 to move to displace and expel the cooled portion of the fuel gas 120 from the intermediate vessel 150. The liquid 170 is forced into the intermediate vessel 150 in a substantially isentropic process. Therefore, work is required to force the liquid 170 back into the intermediate vessel 150. Expelling the cooled fuel gas 120 from the intermediate vessel 150 requires a work input by the positive displacement means 153. This leads to an increase in both the cooled fuel gas 120 in the intermediate vessel 150 and the fuel gas in the receiving vessel 140. As this work input is less than the work extracted in first stage and second stage, a net cooling effect still exists. Where the size of the receiving vessel 140 is large compared to the intermediate vessel 150, the temperature rise due to this work is negligible.

The liquid 170 is forced into the intermediate vessel 150 until it is substantially entirely filled with liquid 170 again as shown in FIG. 2. Once the column is filled with liquid 170 the outlet valve 164 is closed and the method can be repeated by opening the inlet valve 163 so that the fuel gas 120 is received by the intermediate vessel 150 again.

As the fuel gas 120 is transferred from the source vessel 130 to the receiving vessel 140 using the apparatus 110, the work done on the liquid 170 in the first and second stages exceeds the work done on the fuel gas 120 in the third stage. As such, there exists a net output of work from the fuel gas 120. In general, the temperature of the fuel gas 120 received by the receiving vessel 140 may be lower than the temperature of the fuel gas 120 in the source vessel 130. The energy transferred during the work done on the liquid 170 may be dissipated from the apparatus 110 from the liquid or may be used to extract electrical or hydraulic power.

FIG. 8 shows a third embodiment of the apparatus 210 where work done on the liquid 270 is used directly within the apparatus 210 to improve the transfer fuel gas 220 from the source vessel 230 into the receiving vessel 240. Reference numerals in FIG. 8 correspond to those used in FIG. 1 with respect to alike components and features but are transposed by 200.

In the third embodiment, the apparatus 210 comprises the intermediate vessel 250 having the same features as described for the intermediate vessel 150 in second embodiment. The apparatus 210 also comprises an auxiliary intermediate vessel 280 in selective fluid communication with each of the source vessel 230 and the receiving vessel 240. The auxiliary intermediate vessel 280 comprises substantially the same features as the intermediate vessel 250. In particular, an auxiliary inlet valve 265 selectively permits fuel gas 220 to flow from the source vessel 230 to the auxiliary intermediate vessel 280 and an auxiliary outlet valve 266 selectively permits cooled fuel gas 220 to flow from the auxiliary intermediate vessel 280 to the receiving vessel 240. In the embodiment shown in FIG. 8, the positive expander means 253 in each of the intermediate vessel 250 and the auxiliary intermediate vessel 280 is a liquid column containing a liquid 270. A second outlet 272 of the auxiliary intermediate vessel 280 is in selective fluid communication with the second outlet 271 of the intermediate vessel 250. Thus, displacement of liquid 270 in the intermediate vessel 250 causes displacement of liquid 270 in the auxiliary intermediate vessel 280. In the embodiment shown in FIG. 8, a fluid circuit 290 fluidly couples the second outlet 271 of the intermediate vessel 250 to the second outlet 272 of the auxiliary intermediate vessel 280. The fluid circuit 290 may include a control valve 291 to selectively permit the flow of liquid 270 through the fluid circuit 290. Thus, when the control valve 291 is closed liquid 270 cannot flow through the fluid circuit 190 from the intermediate vessel 250 to the auxiliary intermediate vessel 280. Additionally, the fluid circuit 290 may comprise a flow sensor 292. The control valve 291 and flow sensor 292 may be used to control the rate at which liquid 270 flows through the fluid circuit 290 between the intermediate vessel 250 and the auxiliary intermediate vessel 280; thus, the flow of the fuel gas 220 may be controlled. The fluid circuit 290 may additionally comprise a heat exchanger 293. During use, work done on the liquid 270 by the fuel gas 220 may increase the temperature of the liquid 270 as it passes through the fluid circuit 290. The heat exchanger 293 may be used to cool the liquid 270 as it passes through the fluid circuit 290. In certain embodiments, the heat exchange 293 may comprise an ambient heat exchanger. Alternatively, a turbine may be used instead of or in addition to the heat exchanger 293.

The method of transferring and cooling fuel gas 220 using the apparatus 210 of the third embodiment may start with the apparatus 210 in an initial state where the intermediate vessel 250 is substantially entirely filled with liquid 270 and the auxiliary intermediate vessel 280 is substantially entirely filled with fuel gas 220. The fuel gas 220 within the auxiliary intermediate vessel 280 may be a cooled portion of fuel gas 220. The input and output valves 263, 264, 265, 266 of the intermediate and auxiliary intermediate vessels 250, 280 are closed in the initial state.

Fuel gas 220 may be transferred through the apparatus 210 by opening the input valve 263 of the intermediate vessel 250 and the output valve 266 of the auxiliary intermediate vessel 280. Fuel gas 220 is then transferred from the source vessel 230 to the intermediate vessel 250 in the same manner as described in stage 1 of the method for the second embodiment. As fuel gas 220 displaces the liquid 270 in the intermediate vessel 250, the liquid 270 flows through the fluid circuit 290 and into the auxiliary intermediate vessel 280 as shown in FIG. 8. Since the output valve 266 of the auxiliary intermediate vessel 280 is open, the liquid 270 entering the auxiliary intermediate vessel 280 displaces fuel gas 220 within the auxiliary intermediate vessel 280. The displaced fuel gas 220 is forced from the auxiliary intermediate vessel 280 into the receiving vessel 240.

The fuel gas 220 may continue to fill the intermediate vessel 250, displacing the liquid 270, until the amount of fuel gas 220 admitted would have substantially the same pressure as the receiving vessel 240 if the fuel gas 220 expanded to entirely fill the intermediate vessel. Once a sufficient amount of fuel gas 220 has been received by the intermediate vessel 250, the inlet valve 263 of the intermediate vessel 250 is closed. When the inlet valve 263 is closed, each of the intermediate and the auxiliary intermediate vessels 250, 280 are partially filled with liquid 270 and partially filled with fuel gas 220. The fuel gas 220 in the intermediate vessel 250 is then allowed or caused to expand until it substantially entirely fills the intermediate vessel 250 as described in the second stage of the method of the second embodiment. During the expansion, the liquid 270 displaced from intermediate vessel 250 the flows through the fluid circuit and into the auxiliary intermediate vessel 280. The liquid 270 displaces the remaining fuel gas 220 in the auxiliary intermediate vessel 280, forcing the remaining fuel gas 220 into the receiving vessel 240. The liquid 270 is displaced until the intermediate vessel 250 is substantially filled with cooled fuel gas 220 and the auxiliary intermediate vessel 280 is substantially filled with liquid 270. Once the auxiliary intermediate vessel 280 is substantially filled with liquid 270, the output valve 166 of the auxiliary intermediate vessel 280 is closed.

The apparatus 210 is now in a similar state to the initial state but with the contents of the intermediate vessel 250 and the auxiliary intermediate vessel 280 reversed. Therefore, the method of transferring and cooling fuel gas 220 using the apparatus 210 can be repeated but starting from an initial state where the auxiliary intermediate vessel 280 is substantially entirely filled with liquid 270 and the intermediate vessel 250 is substantially entirely filled with fuel gas 220. During the transfer of fuel gas 220 from the source vessel 230 to the receiving vessel 240, the control valve 291 and the flow sensor 292 may be used to control the flow rate of liquid 270 through the fluid circuit 290. Thus, controlling the flow of fuel gas 220 from the source vessel 230.

As discussed in the first embodiment, the positive displacement expander means is not limited to the liquid column of the second and third embodiments. The positive displacement expander means may comprise a diaphragm, a piston, or other suitable mean, as will be described in relation to the fourth and fifth embodiments of the invention.

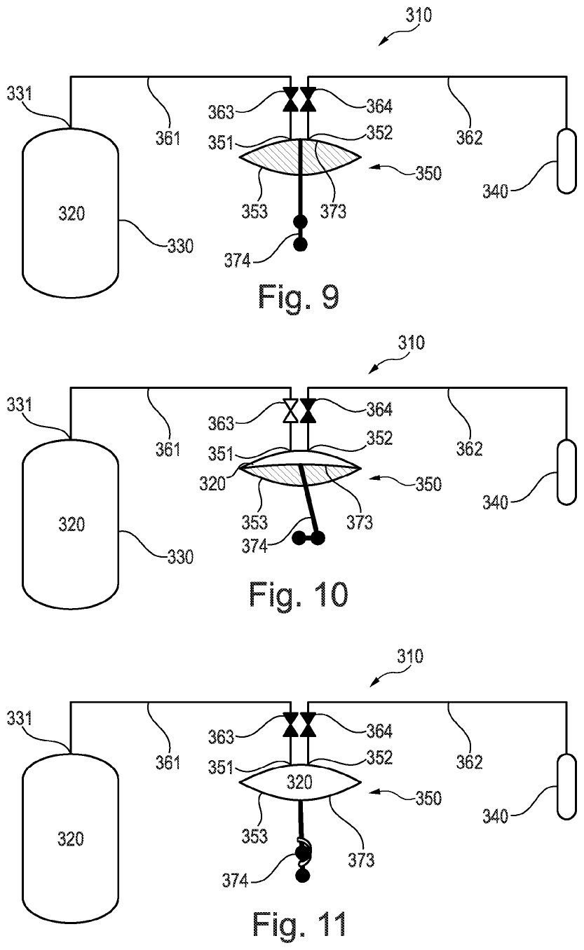

The fourth embodiment of the apparatus 310 is schematically shown in FIGS. 9 to 12, where the positive displacement expander means 353 comprises a diaphragm expander. Reference numerals in FIGS. 9 to 12 correspond to those used in FIG. 1 with respect to alike components and features but are transposed by 300. The apparatus 310 comprises an intermediate vessel 350 that includes a diaphragm 373. The intermediate vessel 350 has an inlet 351 for receiving the portion of fuel gas 320 from the source vessel 330. The inlet 351 is fluidly connected to the first fluid pathway 361. Additionally, the intermediate vessel 350 has an outlet 352 in fluid communication with the second fluid pathway 362. In use, the diaphragm is moveable by the portion of fuel gas 320 received in the intermediate vessel 350. An actuator or actuator means 374 is coupled to the diaphragm 373 and the diaphragm 373 is moveable in response to movement of the actuator 374. In certain embodiments, the actuator 374 may be a mechanical linkage or a hydraulic fluid. Using a diaphragm expander as the positive displacement expander means 353 is advantageous because the fuel gas 320 only contacts a compression box and a diaphragm of the device. As such, the fuel gas 320 is not contaminated by contact with any lubricating or actuating oils.

FIGS. 9 to 12 illustrate the method of transferring and cooling fuel gas 320 using the apparatus 310 according to the fourth embodiment. FIG. 9 shows the initial state of the apparatus 310 where the inlet and the outlet valves 363, 364 are closed and the diaphragm is substantially empty of fuel gas 320. The method is substantially similar to that described for the second embodiment. Only the differences in the method resulting from the diaphragm being the positive displacement expander means 353 are described below in relation to the fourth embodiment.

FIG. 10 shows the apparatus 310 in the first stage of the method where the intermediate vessel 350 receives a portion of the fuel gas 320 from the source vessel 330. The diaphragm 373 expands with the fuel gas 320 as the fuel gas 320 enters the intermediate vessel 350. Thus, work is transferred to the actuator 374. The expansion results in cooling of the fuel gas 320 in both the source vessel 330 and the intermediate vessel 350. The fuel gas 320 continues to fill the intermediate vessel 350 until the amount of fuel gas 320 admitted would have substantially the same pressure as the receiving vessel 340 if the diaphragm expanded to approximately its maximum volume. Once a sufficient amount of fuel gas 320 has been received by the intermediate vessel 350, the inlet valve 363 is closed. When the inlet valve 363 is closed, the diaphragm 374 is partially expanded as shown in FIG. 10.

FIG. 11 shows the apparatus 310 in the second stage of the method where the fuel gas 320 is caused or allowed to expand further in the intermediate vessel 350, further cooling the portion of the fuel gas 320 in the intermediate vessel 350. Both the inlet and outlet valves 363, 364 remain closed whilst the fuel gas 320 is expanded further. As the fuel gas 320 expands, work is done on the diaphragm 373 resulting in a reduction of the pressure and temperature of the fuel gas 320. The fuel gas 320 expands until the diaphragm expands to substantially its maximum volume as shown in FIG. 11

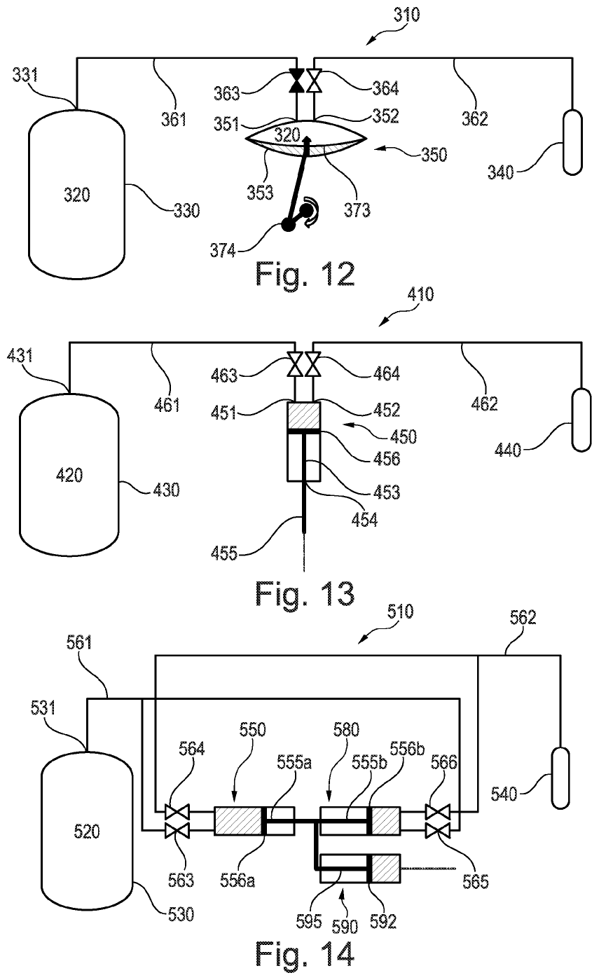

FIG. 12 shows the third stage of the method where the cooled portion of the fuel gas 320 is released from the intermediate vessel 350 to the receiving vessel 340. Once the diaphragm has expanded to substantially its maximum extent, the outlet valve 364 is opened. The actuator 374 is used to compress the diaphragm 373. Thus, the actuator caused the diaphragm to move so as to displace and expel the cooled portion of the fuel gas 320 from the intermediate vessel 250. The fuel gas 320 flows along the second fluid pathway 362 into the receiving vessel 340. Once fuel gas 320 has been substantially expelled from the diaphragm 373, the outlet valve 364 is closed and the method can be repeated by opening the inlet valve 363 so that the fuel gas 320 is received by the intermediate vessel 350 again.

The apparatus 310 of the fourth embodiment may be modified so that work done on the actuator 372 is used directly within the apparatus 310 to improve the transfer of fuel gas 220 from the source vessel 320 into the receiving vessel 240. This may be achieved in a similar manner to the third embodiment shown in FIG. 8. For example, the apparatus 310 may be modified to further comprise an auxiliary intermediate vessel that includes a diaphragm. To transfer work between the diaphragm in the intermediate vessel and the auxiliary intermediate vessel, the diaphragms may be connected either mechanically (i.e. a mechanical connection between the actuators of the diaphragms) or the diaphragms may share a common reservoir of hydraulic fluid.

The fifth embodiment of the apparatus 410 is schematically shown in FIG. 13, where the positive displacement expander means 453 comprises a piston 456. Reference numerals in FIG. 13 correspond to those used in FIG. 1 with respect to alike components and features but are transposed by 400. The intermediate vessel 450 has an inlet 451 for receiving the portion of fuel gas 420 from the source vessel 430. The inlet 451 is fluidly connected to the first fluid pathway 461. Additionally, the intermediate vessel 450 has a first outlet 452 in fluid communication with the second fluid pathway 462. The intermediate vessel 450 may have an opening 454 through which a drive shaft 455 of the piston 456 passes. The piston 456 is sealed to prevent fuel gas 420 escaping from the intermediate vessel 450. As such, the piston 456 requires lubrication to reduce wear on the components.

The method of transferring and cooling fuel gas 420 using the apparatus 440 is substantially the same as described for the second embodiment where the positive displacement expander means is a liquid column. Only the differences in the method resulting from use of the piston 456 are described below.

In the initial state, the piston 456 is substantially fully inserted into the intermediate vessel 450 and the inlet and the outlet valves 463, 464 are closed. In the first stage of the method, the fuel gas 420 expands as it enters the intermediate vessel 450 transferring work to the piston 456 and displacing the piston 456 within the intermediate vessel 450. The fuel gas 420 continues to fill the intermediate vessel 450 until the amount of fuel gas 420 admitted would have substantially the same pressure as the receiving vessel 440 if the fuel gas 420 expanded to substantially fill maximum volume allowed by the piston 456 in the intermediate vessel 450. In the second stage of the method, the piston 456 is released to allow the fuel gas 420 to expand to substantially fill maximum volume allowed by the piston 456. Thus, cooling the fuel gas 420 in the intermediate vessel 450. In the third stage of the method, the piston 456 is forced into the intermediate vessel 450 causing the fuel gas 420 to be expelled from the intermediate vessel 450 and flow along the second pathway into the receiving vessel 440. An actuator or actuator means (not shown) may be used to cause the piston 456 to move so as to displace and expel the cooled portion of fuel gas 420 from the intermediate vessel 450. The piston 456 is forced into the intermediate vessel 450 until it is substantially fully inserted into the intermediate vessel 450 and the cooled fuel gas 420 has been substantially expelled.

The apparatus 410 has a net output of energy. The work done on the piston 456 in the first and second stages exceeds the work done on the fuel gas 420 in the third stage. The energy transferred during the work done on the piston 456 may be dissipated from the apparatus 410 or may be used to extract electrical or hydraulic power. FIG. 14 shows a sixth embodiment of the invention where work done on the piston 556a is directly used within the apparatus. The apparatus uses the work done during the transfer of fuel gas in a similar manner to the third embodiment shown in FIG. 8. Reference numerals in FIG. 14 correspond to those used in FIG. 8 with respect to alike components and features but are transposed by 300.

In the sixth embodiment, the apparatus 510 comprises the intermediate vessel 550 having the same features as described for the intermediate vessel 450 in fifth embodiment. The apparatus 500 also comprises an auxiliary intermediate vessel 580 in selective fluid communication with each of the source vessel 530 and the receiving vessel 540. The auxiliary intermediate vessel 580 comprises substantially the same features as the intermediate vessel 550. In particular, an auxiliary inlet valve 565 selectively permits fuel gas 550 to flow from the source vessel 530 to the auxiliary intermediate vessel 580 and an auxiliary outlet valve 566 selectively permits cooled fuel gas 520 to flow from the auxiliary intermediate vessel 580 to the receiving vessel 540. The positive expander means 553 in each of the intermediate vessel 550 and the auxiliary intermediate vessel 580 is a piston 556a, 556b. As shown in FIG. 14, the drive shaft 555a of the piston 556a in the intermediate vessel 550 is coupled to the drive shaft 555b of the piston 556b in the auxiliary intermediate vessel 580. Therefore, movement of the piston 556a within the intermediate vessel 550 causes movement of the piston 556b within the auxiliary intermediate vessel 580. The apparatus 510 also comprises a control vessel 590. The control vessel 590 comprises a control piston 592 having a drive shaft 595. As shown in FIG. 14, the drive shaft 595 of the control piston 592 is coupled to the drive shaft 555a of the piston 556a in the intermediate vessel 550 and the drive shaft 555b of the piston 556b in the auxiliary intermediate vessel 580.

The apparatus 510 may be used to transfer and cool fuel gas 520 in substantially the same way as the apparatus 210 of the third embodiment shown in FIG. 8. As such, the method of transferring the fuel gas 520 will not be repeated. The pistons 556a, 556b in the intermediate vessel 550 and auxiliary intermediate vessel 590 in the sixth embodiment fulfil a similar function to the liquid 270 contained in the intermediate 250 and auxiliary intermediate 270 vessels of the third embodiment. The coupling of the pistons 556a, 556b in the intermediate vessel 550 and auxiliary intermediate vessel 570 transfers work done on the piston in one vessel to the fuel gas 520 contained within the other vessel. Additionally, the control vessel 590 and corresponding control piston 592 fulfil a similar function the fluid circuit 290 and flow controller 292 of the third embodiment. Through the coupling of the control piston 592 to the pistons 556a, 556b in the intermediate vessel 550 and auxiliary intermediate vessel 570, the control piston 592 may be used to extract power from or dampen the apparatus 510. Thus, controlling the flow of fuel gas 520 from the source vessel 530.

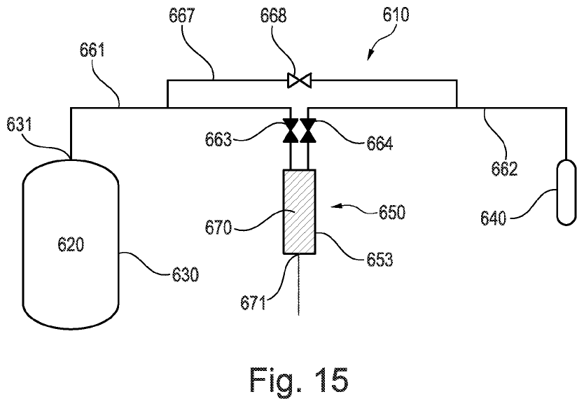

The embodiments of the apparatus described above cool a fuel gas from a source vessel so that the temperature of the fuel gas received by a receiving vessel is lower than the temperature of the fuel gas in the source vessel. FIG. 15 shows an apparatus 610 according to a seventh embodiment of present invention comprising an additional fluid pathway which may be used to raise the temperature of the fuel gas 620 within a receiving vessel 640.

The apparatus 610, shown in FIG. 15, is substantially the same at the apparatus shown in FIG. 2. Reference numerals in FIG. 15 correspond to those used in FIG. 2 with respect to alike components and features but are transposed by 500. The apparatus 610 comprises a third fluid pathway 667 connecting the source vessel 630 to the receiving vessel 640 (i.e. without passing through the intermediate vessel 650). A bypass valve 668 is disposed along the third fluid pathway 667 for selectively permitting direct flow of the fuel gas 620 from the source vessel 630 to the receiving vessel 640. As such, the receiving vessel 640 may receive a non-cooled portion of fuel gas 620 from the source vessel 630 via the third fluid pathway 667. The non-cooled fuel gas 620 does not enter the intermediate vessel 650 prior to being received in the receiving vessel 640.

In the same way as described above in the second embodiment, the apparatus 610 cools the fuel gas 620 so that the temperature of the fuel gas 620 received by the receiving vessel 640 is lower than the temperature of the fuel gas 620 in the source vessel 630. The cooling of the fuel gas 620 may result in the temperature of the fuel gas 620 in the receiving vessel 640 falling below a desired threshold. In such situations, the bypass valve 668 may be opened so that fuel gas 620 then flows directly from the source vessel 630 to the receiving vessel 640 without being cooled. Thus, the temperature of the fuel gas 620 in the receiving vessel 640 may be raised to an acceptable value. When the bypass valve 668 is open, the inlet valve 663 and the outlet valve 664 may be closed as shown in FIG. 15.

The third fluid pathway 667 and the bypass valve 668 may be incorporated into the apparatus of any of the first to the sixth embodiments or variations thereof within the scope of the invention. The third fluid pathway 667 may be connected to the first fluid pathway 661 on one side of the bypass valve 668. The third fluid pathway 667 may be connected to second fluid pathway 662 on the opposite side of the bypass valve 668. In alternative embodiments, the third fluid pathway 667 may be connected directly to the source vessel 630 and/or the receiving vessel 640.

Tables 1 to 3 show an example of the properties of a hydrogen gas during process of transferring the gas from a source vessel to a receiving vessel using the apparatus and method discussed above in relation to any of the first, second, fourth and fifth embodiments. In the example, the hydrogen gas is transferred from a source vessel with a volume of 1650 litres to a receiving vessel with a volume of 125 litres where the receiving vessel is initially filled with 125 litres of hydrogen at a pressure of 100 bar. Additionally, the intermediate vessel may hold a volume of up to 1 litre and the initial temperature of the vessels is 288 K. Heat losses and pressure losses in the fluid pathways between the vessels have been neglecting in the example.

The properties of hydrogen gas within the source vessel before the first stage (i.e. before any fuel gas have been received by the intermediate vessel) are shown in table 1. After the first stage, the intermediate vessel has received a portion of the hydrogen gas and is partially filled with hydrogen gas. In the example, the hydrogen gas from the source vessel expands to fill a volume of 0.48 litres of the intermediate vessel. The properties of hydrogen gas contained in the combined volume of the source vessel and the intermediate vessel at the end of the first stage is shown in table 1. Since the volume of the source vessel of 1650 litres is much greater than the volume of gas received by the intermediate vessel of 0.48 litres, the change in temperature caused be the expansion of the gas in negligible. The work done by the hydrogen gas during the first stage is approximately 16.8 kJ.

TABLE 1

| | | Hydrogen gas in the |
|---|---|---|
| | Hydrogen gas in the | source vessel and |
| | source vessel before | intermediate vessel |
| | the first stage | after the first stage |
| Volume (litres) | 1650 | 1650.48 |
| Specific Volume (m³/kg) | 0.043 | 0.043 |
| Density (kg/m³) | 23.80 | 23.79 |
| Mass (kg) | 39.27 | 39.27 |
| Temperature (K) | 288 | 288 |
| Pressure (bar) | 350 | 350 |
| Specific Entropy (kJ/kgK) | 28.644 | 28.644 |
| Specific Enthalpy (kJ/kg) | 3982 | 3982 |

Table 2 shows the properties of the hydrogen gas in the intermediate vessel before and after the second stage where the hydrogen gas is caused or allowed to expand further in the intermediate vessel. Before the further expansion of gas, the inlet and outlet valves on the fluid pathways are closed. Thus, the intermediate vessel is fluidly isolated from the source vessel and the receiving vessel. During second stage, the volume of the fuel gas in the intermediate vessel expands from 0.48 litres to 1.00 litres. The expansion of the hydrogen gas results in a decrease of the pressure and temperature of the gas. The pressure of the hydrogen gas in the intermediate vessel at the end of the second stage is the same as the pressure if the gas in the receiving vessel. The work done by the hydrogen gas during the second stage is approximately 15.9 kJ.

TABLE 2

| | Hydrogen gas in the | Hydrogen gas in the |
|---|---|---|
| | intermediate vessel | intermediate vessel |
| | before further | after further |
| | expansion | expansion |
| Volume (litres) | 0.48 | 1.00 |
| Specific Volume (m³/kg) | 0.043 | 0.089 |
| Density (kg/m³) | 23.80 | 11.27 |
| Mass (kg) | 0.0113 | 0.0113 |
| Temperature (K) | 288 | 200 |
| Pressure (bar) | 350 | 100 |
| Specific Entropy (kJ/kgK) | 28.644 | 28.621 |
| Specific Enthalpy (kJ/kg) | 3982 | 2575 |

Table 3 shows the properties of the hydrogen gas in the receiving vessel before and after the third stage where the hydrogen is released from the intermediate vessel into the receiving vessel. Before the hydrogen gas is released, the receiving vessel contains a 125 litres of hydrogen with a pressure of 100 bar and temperature of 288 K. During the third stage, the hydrogen gas in the intermediate vessel is forced into the receiving vessel. Since the receiving vessel has a fixed volume, the hydrogen gas is compressed as it enters the receiving vessel causing the pressure of the hydrogen gas to increase. Additionally, forcing the cooled hydrogen gas from the intermediate vessel into the receiving vessel results in a change of temperature in the gas in the receiving vessel as shown in table 3. The work done on the hydrogen gas during the third stage (expulsion) is approximately 10.0 kJ. Therefore, the net work output of the transfer of hydrogen gas from the source vessel to the receiving vessel is 22.7 kJ.

TABLE 3

| | Hydrogen gas in | Hydrogen gas in |
|---|---|---|
| | the receiving vessel | the receiving vessel |
| | before release of | after gas |
| | gas from | from intermediate |
| | intermediate vessel | vessel transferred |
| Volume (l) | 125 | 125 |
| Specific Volume (m³/kg) | 0.126 | 0.125 |
| Density (kg/m³) | 7.941 | 8.032 |
| Mass (kg) | 0.9926 | 1.004 |
| Temperature (K) | 288 | 287.6 |
| Pressure (bar) | 100 | 101.22 |
| Specific Entropy (kJ/kgK) | 33.841 | 33.792 |
| Specific Enthalpy (kJ/kg) | 3833 | 3828 |

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of cooling a compressed fuel gas during transfer of the gas from a source vessel to a receiving vessel, the method comprising:
receiving a portion of the fuel gas from the source vessel in an intermediate vessel;
fluidly isolating the intermediate vessel from the source vessel;
causing or allowing expansion of the portion of fuel gas in the intermediate vessel thereby cooling the fuel gas;
releasing the cooled portion of fuel gas from the intermediate vessel to the receiving vessel.

2. The method according to claim 1, wherein the fuel gas in the source vessel has a pressure greater than 100 bar.

3. The method according to claim 1, wherein the fuel gas is or includes hydrogen, methane, or biogas.

4. (canceled)

5. (canceled)

6. (canceled)

7. The method according to claim 1, wherein an auxiliary intermediate vessel is provided that is in selective fluid communication with each of the source vessel and the receiving vessel such that a further portion of fuel gas may be: (i) received from the source vessel in the auxiliary intermediate vessel, (ii) caused or allowed to expand and thereby be cooled, and (iii) subsequently released to the receiving vessel.

8. The method according to claim 1, wherein work is extracted from the expanding portion of fuel gas by positive displacement.

9. The method according to claim 8, wherein the intermediate vessel contains a liquid that is displaceable out of a second outlet of the intermediate vessel by the portion of fuel gas received in the intermediate vessel, and wherein the liquid is further displaced out of the second outlet during expansion of the portion of fuel gas.

10. A method according to claim 9, wherein the liquid is an ionic liquid.

11. (canceled)

12. (canceled)

13. (canceled)

14. The method according to claim 9, wherein an auxiliary intermediate vessel is provided that is in selective fluid communication with each of the source vessel and the receiving vessel such that a further portion of fuel gas may be: (i) received from the source vessel in the auxiliary intermediate vessel, (ii) caused or allowed to expand and thereby be cooled, and (iii) subsequently released to the receiving vessel; and
wherein the auxiliary intermediate vessel contains a liquid that is displaceable out of a second outlet of the auxiliary intermediate vessel and wherein the second outlet of the auxiliary intermediate vessel is in selective fluid communication with the second outlet of the intermediate vessel such that displacement of liquid in the intermediate vessel may cause displacement of liquid in the auxiliary intermediate vessel.

15. The method according to claim 1, wherein the intermediate vessel contains a diaphragm that is moveable by the portion of fuel gas received in the intermediate vessel.

16. (canceled)

17. The method according to claim 1, wherein the intermediate vessel contains a piston that is moveable by the portion of gas received in the intermediate vessel.

18. (canceled)

19. (canceled)

20. An apparatus for transferring and cooling a compressed fuel gas comprising:
a source vessel for containing the fuel gas;
an intermediate vessel fluidly connected to the source vessel by a first fluid pathway, the intermediate vessel including a positive displacement expander means;
an inlet valve along the first fluid pathway for selectively permitting fuel gas to flow along the first fluid pathway;
a second fluid pathway connected to the intermediate vessel and connectable to a receiving vessel; and
an outlet valve along the second fluid pathway for selectively permitting fuel gas to flow along the second fluid pathway;
wherein the intermediate vessel is configured to receive a portion of fuel gas from the source vessel and the positive displacement expander means may be displaced by the portion of fuel gas so as to extract work from the portion of fuel gas and cause it to cool, whereby the cooled portion of fuel gas may be released from the intermediate vessel to the receiving vessel.

21. (canceled)

22. The apparatus according to claim 20, wherein the source vessel contains a fuel gas that has a pressure greater than 100 bar.

23. The apparatus according to claim 20, wherein the source vessel contains a fuel gas that is or includes hydrogen, methane, or biogas.

24. The apparatus according to claim 20, further comprising an auxiliary intermediate vessel that is in selective fluid communication with each of the source vessel and the receiving vessel such that a further portion of fuel gas may be: (i) received from the source vessel in the auxiliary intermediate vessel, (ii) caused or allowed to expand and thereby be cooled, and (iii) subsequently released to the receiving vessel.

25. The apparatus according to claim 20, wherein the positive displacement expander means comprises a liquid contained in the intermediate vessel that is displaceable out of a second outlet of the intermediate vessel by the portion of fuel gas received in the intermediate vessel, and wherein the liquid is further displaced out of the second outlet during expansion of the portion of fuel gas.

26. The apparatus according to claim 25, wherein the liquid is an ionic liquid.

27. (canceled)

28. (canceled)

29. (canceled)

30. The apparatus according to claim 25, further comprising an auxiliary intermediate vessel that is in selective fluid communication with each of the source vessel and the receiving vessel such that a further portion of fuel gas may be: (i) received from the source vessel in the auxiliary intermediate vessel, (ii) caused or allowed to expand and thereby be cooled, and (iii) subsequently released to the receiving vessel, wherein the auxiliary intermediate vessel contains a liquid that is displaceable out of a second outlet of the auxiliary intermediate vessel and wherein the second outlet of the auxiliary intermediate vessel is in selective fluid communication with the second outlet of the intermediate vessel such that displacement of liquid in the intermediate vessel may cause displacement of liquid in the auxiliary intermediate vessel.

31. The apparatus according to claim 20, wherein the positive displacement expander means comprises a diaphragm that is moveable in the intermediate vessel by the portion of fuel gas received in the intermediate vessel.

32. (canceled)

33. The apparatus according to claim 20, wherein the positive displacement expander means comprises a piston that is moveable in the intermediate vessel by the portion of fuel gas received in the intermediate vessel.

34. (canceled)

35. (canceled)

36. The apparatus according to claim 20, further comprising a receiving vessel connected to the intermediate vessel by the second fluid pathway, optionally wherein the receiving vessel comprises an automobile fuel tank.

37. (canceled)
